(19) United States
(12) Patent Application Publication
(10) Pub. No.: US 2004/0218704 A1
(43) Pub. Date: Nov. 4, 2004

(54) Timing adjusting apparatus

(75) Inventor: Norio Fujii, Kyoto (JP)

Correspondence Address: MORGAN LEWIS & BOCKIUS LLP, 1111 PENNSYLVANIA AVENUE NW, WASHINGTON, DC, 20004, US

(73) Assignee: Rohm Co., Ltd.

(21) Appl. No.: 10/779,845

(22) Filed: Feb. 18, 2004

(30) Foreign Application Priority Data
Feb. 26, 2003 (JP) P2003-049136

(51) Int. Cl. H04L 7/00

(52) U.S. Cl. 375/354

(57) ABSTRACT

An input signal Vina is converted into a digital signal by an AD converter 10 and output as a digitized input signal Vind. A counter circuit 20 sets a count number based on the digitized input signal Vind and starts to count a counter clock signal CLKc upon a trigger signal TRG, and generates an output signal Sout when the count number is obtained.

### BACKGROUND OF THE INVENTION

1. Field of the Invention

The present invention relates to a timing adjusting apparatus to be used for adjusting a timing of an index signal of a magnetic disk device or an optical disk device such as a Floppy disk device (hereinafter referred to as an FDD) or a PG signal of a video tape recorder (VTR or VCR).

2. Description of the Related Art

In a magnetic disk device such as an FDD, conventionally, a pulse signal is generated for one rotation of a disk, which is written onto a recording track as the index signal to determine the start timing of the recording track. The start timing of the index signal should be generated in the specific rotating angle position of a disk from a need of keeping the compatibility of the disk. However, as for precision in the alignment of assembling the index signal generating means for generating the index signal, it is estimated in that an error with approximately a few degrees is not avoidable in general manner. Therefore, the timing adjustment of the generated index signal is made in such a way that the error can be corrected for actual use.

There has been disclosed a timing adjusting apparatus as shown in JP No. 2546223, which is comprised of a first current source for causing a first current to be a reference to flow, a second current source for causing a second current capable of being controlled optionally to flow, and a capacitor of which specific voltage value is discharged (or charged) by the first current during a predetermined period from the timing of generation of an index signal, and thereafter said capacitor is discharged (or charged) to the specific voltage value by the second current so that appropriate timing adjustment can be made.

However, since the conventional timing control apparatus makes use of the charge and discharge of a capacitor to control the timing, it is required to use the capacitor. Therefore in case of the timing adjusting apparatus being fabricated into the IC chip, the capacitor shall be prepared separately as an external component, which increases the manufacturing cost. Moreover, due to the specific pins being additionally required to secure a connection to the external capacitor, downsizing the dimension of the IC chip becomes difficult.

### SUMMARY OF THE INVENTION

Therefore, it is an object of the invention to provide a timing adjusting apparatus for adjusting a time, which can set its necessary time in high precision without using a capacitor so as to lower a drift of the predetermined adjust time.

A first aspect of the invention is directed to a timing adjusting apparatus comprising: an AD converter 10 for receiving an input signal of which input signal level is converted into a digital signal to generate a digitized input signal; and

a counter circuit 20 to which the digitized input signal, a counter clock signal and a trigger signal are provided so as to set a count number based on the digitized input signal and start counting the counter clock signal in response to the trigger signal, wherein an output signal is generated from the counter circuit at the timing of the counter clock signal reaching the count number.

A second aspect of the invention is directed to the timing adjusting apparatus according to the first aspect of the invention, wherein the digitized input signal Vind is set for the count number when the trigger signal is input.

A third aspect of the invention is directed to the timing adjusting apparatus according to the first or second aspect of the invention, wherein said AD converter 10 is further comprising: a binary-coded N-bit output counter 13 for counting an input clock signal and carrying out a count operation repeatedly; a DA converter for converting an N-bit output signal of the binary-coded N-bit output counter into a counter analog signal, and outputting the counter analog signal; a comparator for comparing the input signal with the counter analog signal to output a comparison output signal; and a latch circuit for inputting the N-bit output signal as data, latching the N-bit output signal, and outputting the latched N-bit output signal as the digitized input signal in accordance with a change of the comparison output signal.

A fourth aspect of the invention is directed to the timing adjusting apparatus according to the third aspect of the invention, wherein the counter clock signal CLKc is one of the N-bit output signals Q1 to Q4.

### BRIEF DESCRIPTION OF THE DRAWINGS

FIG. 1 is a diagram showing the structure of a timing adjusting apparatus according to a first embodiment of the invention,

FIG. 2 is a timing chart for explaining an operation in FIG. 1,

FIG. 3 is a diagram showing the structure of a timing adjusting apparatus according to a second embodiment of the invention, and

FIG. 4 is a timing chart for explaining the operation of an AD converter 10 in FIG. 3.

### DESCRIPTION OF THE PREFERRED EMBODIMENTS

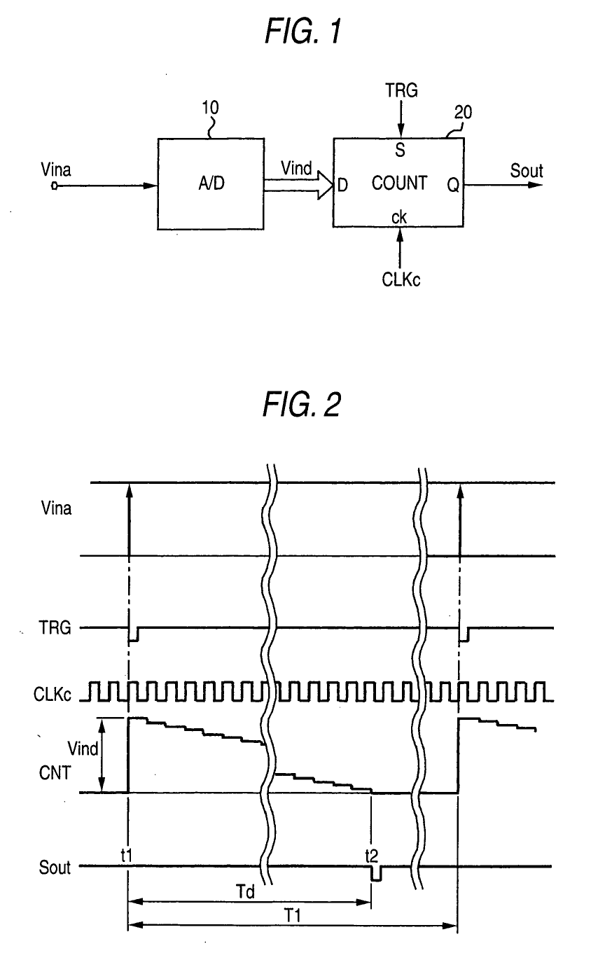

An embodiment of a timing adjusting apparatus according to the invention will be described below with reference to the drawings. FIG. 1 is a diagram showing the structure of a timing adjusting apparatus according to a first embodiment of the invention. FIG. 2 is a timing chart for explaining an operation in FIG. 1. The timing adjusting apparatus is fabricated in a single IC chip.

In FIG. 1, an AD converter 10 receives an input signal Vina and converts an input signal level thereof into a digital signal which is output as a digitized input signal Vind. A counter circuit (COUNT) 20 receives the digitized input signal Vind at a data input terminal D, a counter clock signal CLKc at a clock input terminal CK, and a trigger signal TRG at a set terminal S respectively.

Then, upon a count number corresponding to the digitized input signal Vind being set to the counter circuit 20 by the trigger signal TRG, the counter circuit 20 starts counting the counter clock signal CLKc until the set count number is completely counted, and sends an output signal Sout.

The trigger signal TRG is output once for each rotation of a rotational body such as a motor (approximately 300 RPM in case of an FDD). The output signal Sout is output after a certain delay time from the generation of the trigger signal TRG that is corresponding to a predetermined rotating angle (for example, several degrees). The input signal Vina is controlled to set a delay time which determines the generation timing of the output signal Sout, and the level thereof can be controlled and set by using a volume component (a variable resistance) for instance.

The operation of the timing control apparatus in FIG. 1 will be described with reference to a timing chart of FIG. 2.

First of all, an adjusting time Td for delaying the output signal Sout with respect to the trigger signal TRG is determined and the input signal Vina is arbitrary set to comfort with the adjusting time Td. The scale of the input signal Vina set in this manner is shown in an arrow of FIG. 2.

This input signal Vina is input to the AD converter 10 where said signal is digitally coded into the digitized input signal Vind to be supplied to the data input terminal D of the counter circuit 20. Moreover, the counter clock signal CLKc is continuously supplied to the counter circuit 20.

When the trigger signal TRG is applied to the set terminal S at a time t1, the digitized input signal Vind at that time is set as a count value. At the same time, counting the counter clock signal CLKc is starting up. The trigger signal TRG is synchronized with the counter clock signal CLKc as shown in FIG. 2, for example, but does not necessarily be synchronized.

The counting of the counter clock signal CLKc is continued and said counting stops at a timing of t2 where a count number CNT reaches the count value (that is, Vind). Consequently, the output signal Sout is simultaneously output. A time taken from the count starting timing t1 to the count ending timing t2 of the counter clock signal CLKc comes to be the adjusting time Td after adjustment.

The trigger signal TRG is repeatedly supplied every predetermined cycle T1 in case of the object being a disk-shape or a rotary body. Therefore, the output signal Sout is repeatedly produced every predetermined cycle T1 with a delay of the adjusting time Td.

In the case in which the adjusting time Td is different from a predetermined time or the time is to be changed, the input signal Vina is controlled again to have a proper scale.

In the timing adjusting apparatus in this invention, the count of the counter circuit 20 is set by the digitized input signal Vind that is obtained by digital coding of the input signal Vina, while the counting is carried out by the counter clock signal CLKc. Accordingly, it is possible to set the adjusting time Td corresponding to the input signal Vina with high precision.

Moreover, the precision in the adjusting time Td which is to be set is determined by the counter clock signal CLKc. In such a circuit structure, if the counter clock signal CLKc is stable, then the drift of the adjusting time Td, which is caused by a change in a supply voltage or an ambient temperature, can be more suppressed than that of being generated in the conventional arts. Since the drift of the adjusting time Td is small, furthermore, the clock cycle of the counter clock signal CLKc can be determined depending on the precision in the adjusting time Td to be required.

The timing adjusting apparatus in FIG. 1 can be used for a timing adjustment of an index signal of a magnetic disk device such as an FDD or an optical disk device or a PG signal of a video tape recorder (VTR).

In application to the FDD, the trigger signal TRG is an input index signal which is produced by one pulse for each rotation of the disk, while the output signal Sout is an output index signal which is delayed by a time determined by the specific rotating angle of the disk. Moreover, the input signal Vina is characterized as a delay amount set value for which a command for a time to be delayed is produced. This circuit structure makes it possible to keep the compatibility of the disk by adjusting the timing of the output index signal to be generated in the specific rotating angle position of the disk. It is also possible to apply the invention to various types of the disk systems other than the FDD. Furthermore, the invention is not restricted thereto but can be widely utilized for the timing adjustment of the rotating position of a rotor.

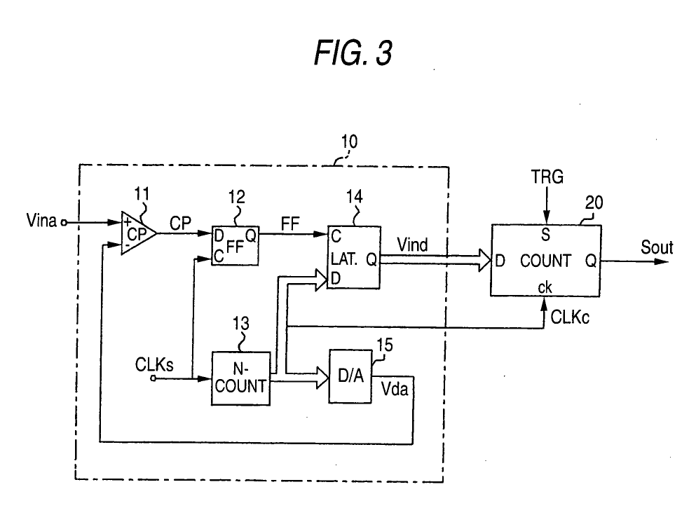

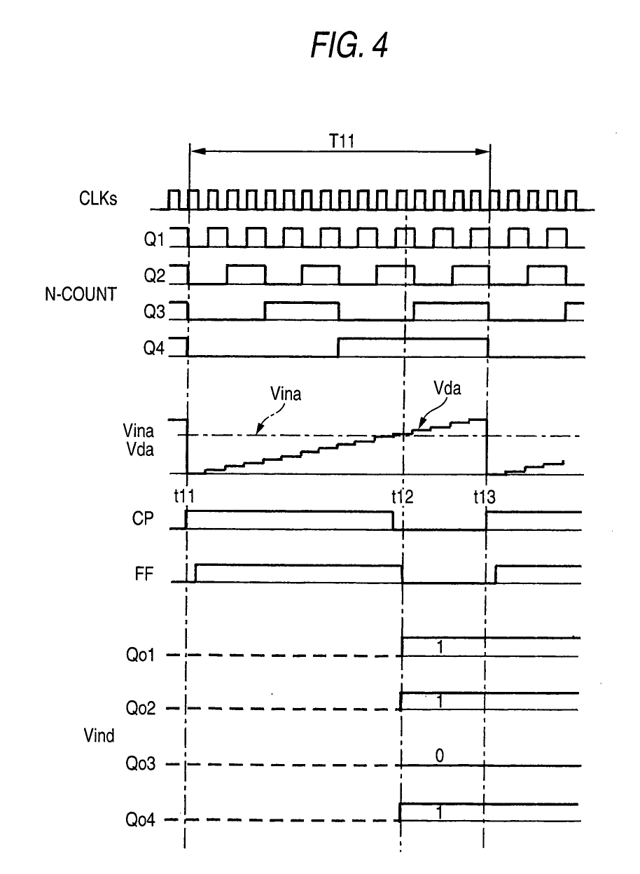

FIG. 3 is a diagram showing the structure of the timing adjusting apparatus according to the first embodiment of the invention, particularly illustrating an example of the specific structure of the AD converter 10. FIG. 4 is a timing chart for explaining the operation of the AD converter 10 in FIG. 3.

FIG. 3 is different from FIG. 1 in that the example of the specific structure of the AD converter 10 is shown and a signal in the AD converter 10 is utilized as the counter clock signal CLKc in relation to said specific structure of AD converter, but the remaining aspects are the same as those in FIG. 1. Different portions will be mainly described below.

First of all, the structure of the AD converter 10 will be described. A binary-coded N-bit output counter (N-COUNT) 13 counts a system clock signal CLKs, which is an input clock signal, and it repeatedly carries out a count operation from an initial value to an end value. The N-bit output counter 13 is structured by a binary-coded 2^{N} digit counter. In this example, the description will be given with N=4, however N might be an arbitrary number. Moreover, binary-coded 2^{N} digit counter is not necessarily limited to this embodiment, rather a counter of any other types might be also adopted to the extent such that it can carry out the repeating count operation.

A DA converter 15 converts the digital inputs, comprising N-bit output signals Q1 to Q4 of the N-bit output counter 13, into the analog signals so as to output a counter analog signal Vda. It is preferable for this embodiment to use a DA converter having a ladder-type resistor circuit, such as an R-2R type, for minimizing a necessary space in case of the circuit being fabricated into an IC chip.

A comparator 11 compares an input signal Vina with the counter analog signal Vda to generate a comparison output CP having an H level when the input signal Vina is greater than the counter analog signal Vda.

The system clock signal CLKs and the comparison output signal CP are input into a D-type flip-flop 12 at a clock terminal C and a data terminal D respectively so as to generate a flip-flop output signal FF.

The N-bit output signals Q1 to Q4 are input into a latch circuit 14 as data at its data terminal D where the N-bit output signals Q1 to Q4 are latched in accordance with a change in the flip-flop output FF (that is, the comparison output CP) of which signal is input to a clock terminal C. Then, said latched N-bit output signals Q1 to Q4 are generated as a digitized input signal Vind toward the counter circuit 20.

Moreover, one of the N-bit output signals Q1 to Q4 (for example, Q4) is utilized for the counter clock signal CLKc that is input to the counter circuit 20. Assuming that the invention is applied to an FDD of 300 RPM, for example, it is sufficient for obtaining precision of 0.2 degree with a resolution of approximately 100 μS for the reason that one rotation (360 degrees) is carried out at 200 ms. If the system clock signal CLKs has a sufficiently high frequency, then the system clock signal CLKs is not necessarily used for the counter clock signal CLKc. In such a case, the N-bit output signals Q1 to Q4, being formed to obtain the digitized input signal Vind, might be used for the counter clock signal CLKc instead of the system clock signal CLKs. As the result, it decreases the counting numbers by the counter circuit 20, which is advantageous for the downsizing of the counter circuit 20.

The operation of the AD converter 10 in the timing adjusting apparatus of FIG. 3 will be described with reference to a timing chart of FIG. 4.

First of all, the input signal Vina which is input to a positive (+) input terminal of the comparator 11 and is compared with the counter analog signal Vda which is input to a negative (−) input terminal.

The N-bit output counter 13 continuously counts the system clock signal CLKs and supplies the N-bit output signals Q1 to Q4 to the latch circuit 14 and the DA converter 15.

The DA converter 15 always converts the input N-bit output signals Q1 to Q4 into digital signals and outputs the counter analog signal Vda.

When a count cycle T11 of the N-bit output counter 13 starts up at a time t11, the counter analog signal Vda is increasing. When the counter analog signal Vda exceeds the input signal Vina, the comparison output CP is changed from an H level state to an L level state. At a time t12 synchronized with the next drop of the system clock signal CLKs, the flip-flop output signal FF drops.

The latch circuit 14 latches, as data signals, the N-bit output signals Q1 to Q4 (1, 1, 0 and 1 in FIG. 4) at the time t12 in response to the drop of the flip-flop output signal FF, and supplies the data signal as the digitized input signal Vind (1, 1, 0 and 1 in FIG. 4) to the counter circuit 20.

When the count cycle T11 of the N-bit output counter 13 is ended at a time t13, the above-mentioned operations are repeatedly carried out.

Once the digitized input signal Vind is latched, the value is kept and updated to the new N-bit output signals Q1 to Q4 in a next count cycle. Therefore, the same digitized input signal Vind is continuously output before the input signal Vina is changed.

The operation of the counter circuit 20 is the same as that in FIG. 1 except that the counter clock signal CLKc is set to be from any one of the N-bit output signals Q1 to Q4.

The timing adjusting apparatus according to the invention is fabricated into the IC chip without using a charging/discharging capacitors, and furthermore, most part of the circuitries can be designed by digital circuits except a part where the input signal Vina and the counter analog signal Vda are compared together, whereby the required space for the IC chip can be also reduced.

According to the timing adjusting apparatus in accordance with the invention, a number of the count is set by the input signal which is digitally coded and the counting is carried out by the counter clock signal. Consequently, this makes it possible to set an adjusting time corresponding to an input signal with high precision. Moreover, the precision in the adjusting time can be determined by the counter clock signal. If the counter clock signal is stable, then the drift of the adjusting time caused by a fluctuation in the supply voltage or its ambient temperature can be lowered better than that of being compensated in the conventional art.

According to the timing adjusting apparatus in accordance with the invention, moreover, a charging/discharging capacitor is not used. Therefore, fabricating into an IC chip can be easily carried out. Furthermore, except a part for comparing the input signals, most part of the IC chip can be designed by the digital circuits. Consequently, a required space for fabricating into an IC can be also reduced.

Furthermore, the N-bit output signal in the AD converter is used as the counter clock signal. Consequently, the number of the count can be decreased whereby the size of the counter circuit becomes smaller.

What is claimed is:

1. A timing adjusting apparatus comprising:
an AD converter for receiving an input signal of which input signal level is converted into a digital signal to generate a digitized input signal; and
a counter circuit to which the digitized input signal, a counter clock signal and a trigger signal are provided so as to set a count number based on the digitized input signal and start counting the counter clock signal in response to the trigger signal, wherein an output signal is generated from the counter circuit at the timing of the counter clock signal reaching the count number.

2. The timing adjusting apparatus according to claim 1, wherein the digitized input signal is set as the count number when the trigger signal is input.

3. The timing adjusting apparatus according to claim 1 or 2, wherein said AD converter is further comprising:
a binary-coded N-bit output counter for counting an input clock signal and carrying out a count operation repeatedly;
a DA converter for converting an N-bit output signal of the binary-coded N-bit output counter into a counter analog signal, and outputting the counter analog signal;
a comparator for comparing the input signal with the counter analog signal to output a comparison output signal; and
a latch circuit for inputting the N-bit output signal as data, latching the N-bit output signal, and outputting the latched N-bit output signal as the digitized input signal in accordance with a change of the comparison output signal.

4. The timing adjusting apparatus according to claim 3, wherein the counter clock signal is selected from one of the N-bit output signals.
